(19) United States
(12) Patent Application Publication
(10) Pub. No.: US 2014/0005985 A1
(43) Pub. Date: Jan. 2, 2014

(54) Computer Aided Apparatus and Computer Aided Method

(71) Applicant: Hitachi, Ltd., Tokyo (JP)

(72) Inventor: Tomotoshi ISHIDA, Hitachinaka (JP)

(21) Appl. No.: 13/916,383

(22) Filed: Jun. 12, 2013

(30) Foreign Application Priority Data
Jun. 29, 2012 (JP) 2012-146290

(51) Int. Cl. G06F 17/50

(52) U.S. Cl. CPC G06F 17/50; G06F 17/5004
USPC 703/1

(57) ABSTRACT

A computer aided apparatus includes an input/output interface for establishing a connection with an input/output apparatus; a storage apparatus including a product data storage section, a detail level data storage section, and a parts list data storage section; and a computing apparatus including an input control section, a detail level determining section, a plurality of parts list data generating sections, the number of which is according to the number of detail levels, and an output control section.

### BACKGROUND OF THE INVENTION

1. Field of the Invention

The present invention relates to an apparatus and a method for aiding design of various industrial products. More particularly, the present invention relates to an apparatus and a method for aiding design of structures such as plants and buildings as objects, and aiding work for performing planning such as production, transportation, and construction, using output results.

2. Description of the Related Art

When a structure such as a plant or a building is constructed, the structure is designed based on the required specification, and the procurement of parts and the production, transportation, and construction of parts are performed based on the design results. Eventually, each operation needs to be performed based on completed design. However, if planning of each operation is started after completion of design, then a deadline may not be met. Thus, it is common to start planning of each operation at the middle stage of design. Namely, parts list data required for each planning such as procurement, production, transportation, and construction needs to be generated using mid-stage design data. Note that as the design progresses, the design data approaches its completion, and thus, it is preferred that data used for planning be based on data generated in a downstream process. Hence, it is preferred to use the latest design data generated at the time of planning.

Under such a background, JP-09-26984-A discloses a method of creating a list of wiring cables from abstract CAD data generated at the early design stage. In the method, CAD data includes the terminal point and route of a wire cable as a continuous line, and a total length in which the length of a route portion of the cable, the length of a connecting portion at the terminal point, a margin portion, etc., are added is computed from those data, and parts list data for required cables is generated.

In addition, JP-2002-227135-A discloses a method of generating parts list data from specification data generated before generating CAD data. In the method, a relationship between main specification values and parts lists is organized in advance for each type of an object structure, and parts list data is generated based on the relationship.

In addition, JP-2004-234338-A discloses a method in which parts list data is generated from detail CAD data generated at the time of completion of design, and procurement of materials, transportation, construction management, etc., are performed based on the data.

### SUMMARY OF THE INVENTION

It may seem that a combination of the disclosed methods enables to generate data required for planning of each operation in a downstream process, using data generated at each of the stages, “prior to design”, “early design stage”, and “after completion of design”.

However, since design progresses gradually, in the middle stage there occurs a mixed state of “abstract” and “detail” in which while some data remains in an abstract state, some data is in a detail state. To generate data for planning at this time by the above-described methods, there is a need to distinguish whether each data is in an abstract state or a detail state. This is because the process of generating parts list data needs to be changed according to which state of data is used.

However, a method for making such a distinction has not been available so far, and thus, a human needs to make a determination. Alternatively, only when all data is prepared in a certain state, parts list data is generated.

The present invention is made in view of the above-described problems, and provides means for allowing to perform different processes in which when abstract CAD data and detail CAD data are mixed, their state levels are determined and parts list data is generated according to the levels.

To solve the above-described problems, a computer-aided apparatus of the present invention includes:

a storage apparatus including a design data storage section that stores design data; a detail level data storage section that stores detail level data representing a detail level of each element of the design data; and a parts list data storage section that stores parts list data representing a list of parts of a structure which is a design object; and

a computing apparatus including an input control section that processes data to be input from an input/output apparatus; a detail level determining section that determines a detail level of the design data; one or a plurality of parts list data generating sections that generates parts list data from the design data and the detail level data, according to the detail level; and an output control section that processes output of various data.

According to the present invention, the following effects can be obtained.

(1) At any point of time during the progress of design, parts list data can be generated based on the latest data closest to its final version, enabling to improve the accuracy of planning. Note that the improvement in the accuracy of planning ends up reducing the construction cost of a structure.

(2) To perform the above, for individual design data, there is no need to input data on distinction between detail levels.

(3) A design progress state can be grasped.

### BRIEF DESCRIPTION OF THE DRAWINGS

FIG. 1 is a diagram schematically showing a computer-aided apparatus and a peripheral device;

FIGS. 2A to 2C are diagrams showing an example of a difference between abstract, intermediate, and detail of design data;

FIG. 3 is a diagram showing an example of a table configuration of design data stored in a design data storage section and an example of the data;

FIG. 4 is a diagram showing an example of a table configuration of detail level data stored in a detail level data storage section and an example of the data;

FIGS. 5A and 5B are diagrams showing examples of a table configuration of parts list data stored in a parts list data storage section and examples of the data;

FIG. 6 is a diagram showing a flow of a process performed by a detail level determining section;

FIG. 7 is a diagram showing a flow of a process performed by a parts list data generating section;

FIGS. 8A and 8B are diagrams showing screens on which parts list data is output and displayed; and

FIGS. 9A and 9B are diagrams showing screens on which detail level data is output and displayed.

### DESCRIPTION OF THE PREFERRED EMBODIMENTS

An embodiment will be described below using the drawings.

### First Embodiment

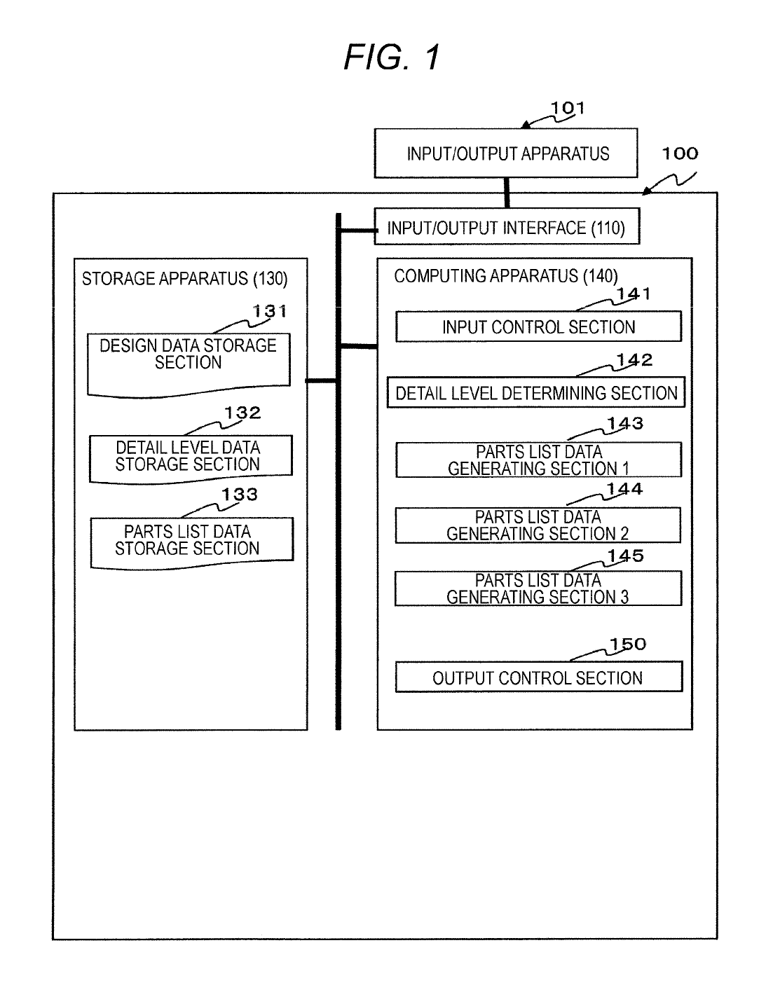

FIG. 1 is a schematic diagram of a computer-aided apparatus (100) of the present invention and a peripheral device.

An input/output apparatus (101) performs, for example, input of design data and parts list data, an instruction for output, and output of generated data. It is preferred that the input/output apparatus (101) be composed of a keyboard, a mouse, a display, a printer, etc., which are common input/output apparatuses of a computing machine. Note, however, that the apparatus configuration is not limited thereto.

An input/output interface (110) is a part of the computer-aided apparatus (100) of the present invention, and exchanges data with the input/output apparatus (101).

A storage apparatus (130) is a portion that stores various data, and includes the following storage sections.

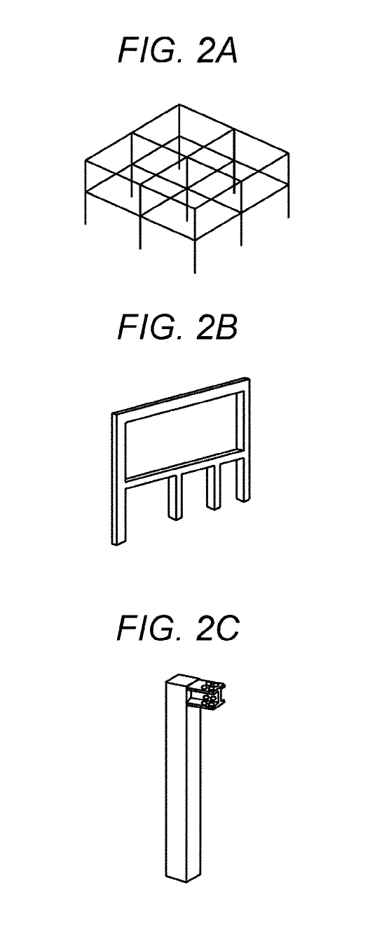

A design data storage section (131) is a portion that stores design data of a structure which is a design object. In the present embodiment, the design data includes geometric data, various attribute data pertaining to geometries, data representing the group relationship and relative relationship between individual geometric data, etc., which are processed by a common CAD system. Even if the geometric representation form is of one type, the content of data to be represented varies depending on the progress of design. For example, for data that represents a column of a structure, in abstract design data at the early design stage, the column is represented by a single line segment (FIG. 2A). However, thereafter, the geometry is changed to a shape steel whose cross-section has the shapes of characters such as “□”, “H”, and “L” (FIG. 2B). Furthermore, in detail design data at the final stage, the column is represented by data in which geometric portions such as a joint and bolt holes at a connecting portion to a brace are added (FIG. 2C). Although the detail design data is configured as data distinguished by parts which are production units, the abstract design data at the early stage may be represented by a single line segment by integrating a plurality of columns which is arranged linearly. At the middle stage, data in both states may be mixed. In addition, each data may come with management number, main dimension, etc., as attributes.

A detail level data storage section (132) is a portion that records the results of a determination which is made by a detail level determining section (142) (described later) as to what detail level the design of each element of the design data stored in the design data storage section (131) has progressed to. In the above-described example of a column, the detail level data storage section (132) records data that distinguishes whether the column is in an abstract state with only a line segment or at the intermediate stage of a shape steel level or at a detail level at the final stage. Not only such a distinction between three stages, but also the level can be represented by a continuous value, e.g., the early stage is 0.0 and the final stage is 1.0.

A parts list data storage section (133) is a portion that stores data on parts lists which is generated by a parts list data generating section 1, a parts list data generating section 2, and a parts list data generating section 3 which will be described later. The parts lists stored in this portion are used for planning such as production, procurement, transportation, and construction which are performed based on design results, and include the management numbers, quantities, types, applications, main dimensions, masses, etc., of parts. These items can be changed according to the purpose.

A computing apparatus (140) includes the following processing sections that process data to be input from the input/output interface (110) and data stored in the storage apparatus (130).

An input control section (141) is a portion that sorts data input from the input/output apparatus (101) and a remote input/output apparatus into instructions, data, etc., and transfers them to corresponding sections of the storage apparatus and the computing apparatus.

The detail level determining section (142) is a portion that determines what detail level the design of each element of the design data stored in the design data storage section (131) has progressed to, and records the results thereof in the detail level data storage section (132).

The parts list data generating section 1 (143) is a portion that generates parts list data from data on those elements, among the elements of the design data stored in the design data storage section (131), whose detail level data recorded in the detail level data storage section (132) is recorded as “abstract”, and records the parts list data in the parts list data storage section (133).

The parts list data generating section 2 (144) is a portion that generates parts list data from data on those elements, among the elements of the design data stored in the design data storage section (131), whose detail level data recorded in the detail level data storage section (132) is recorded as “intermediate”, and records the parts list data in the parts list data storage section (133).

The parts list data generating section 3 (145) is a portion that generates parts list data from data on those elements, among the elements of the design data stored in the design data storage section (131), whose detail level data recorded in the detail level data storage section (132) is recorded as “detail”, and records the parts list data in the parts list data storage section (133).

In the present embodiment, design data has three detail levels, “abstract”, “intermediate”, and “detail”, and thus, the parts list data generating section has three portions (143 to 145) corresponding thereto, respectively; however, the number of the portions may be changed according to the number of levels. Alternatively, a single parts list data generating section may process data of a plurality of levels.

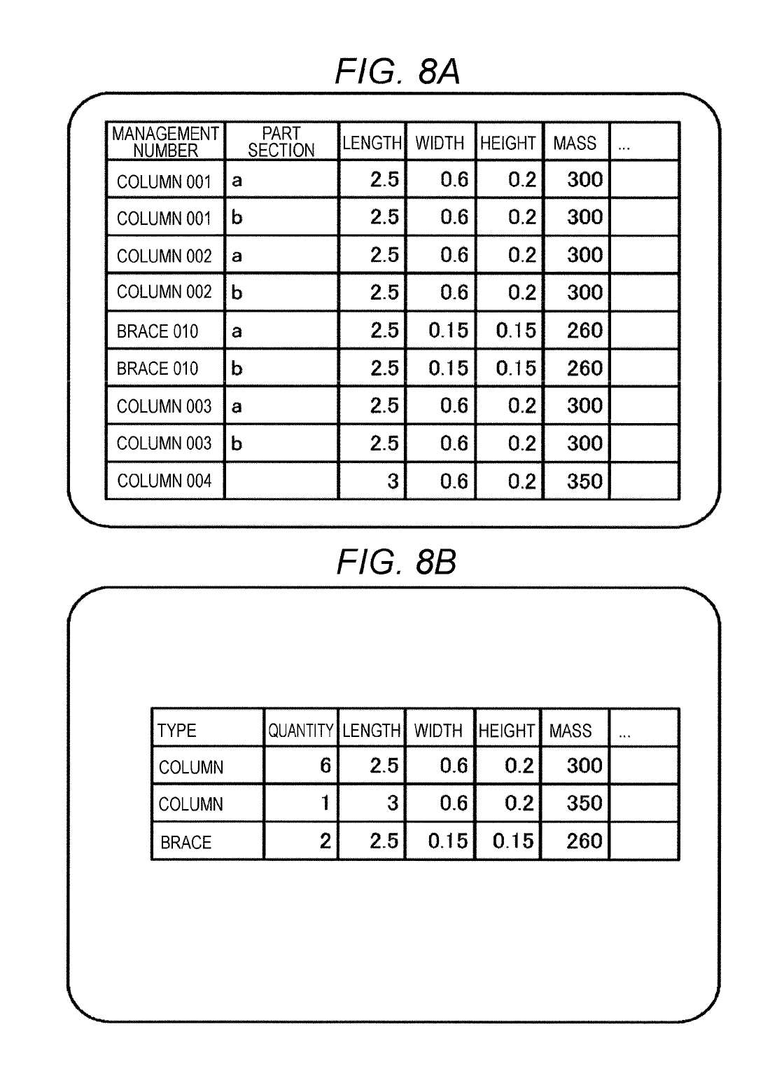

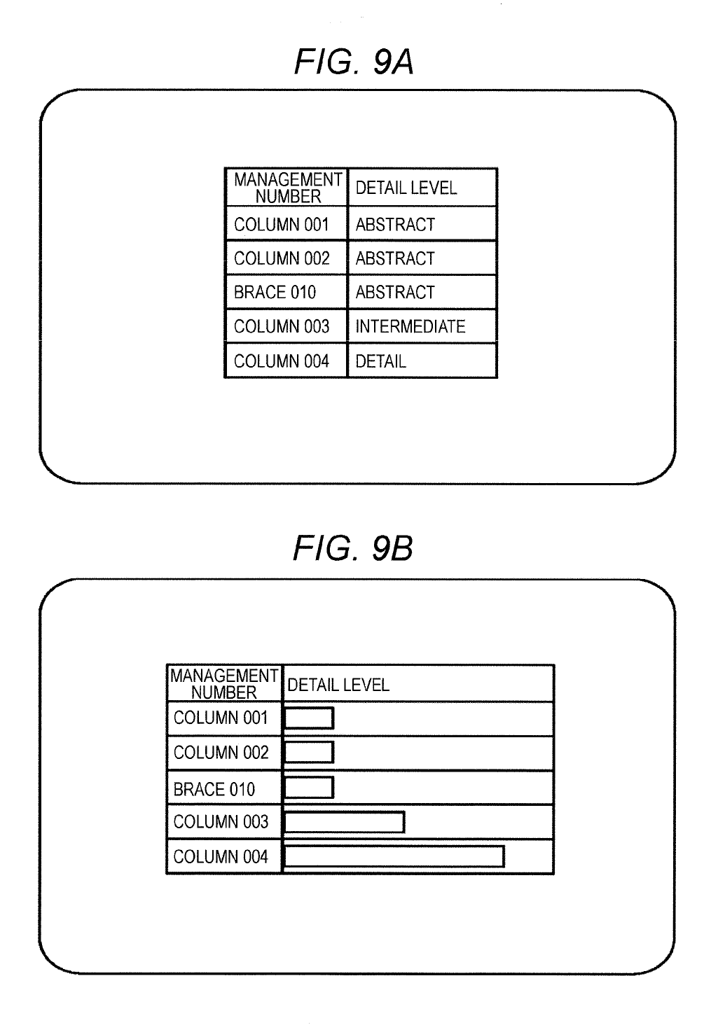

An output control section (150) is a portion that performs control to output data stored in each section in the storage apparatus (130) and transfers the data to the input/output apparatus (101). The parts list data recorded in the parts list data storage section (133) can be displayed on a screen in the manner shown in FIGS. 8A and 8B, or can also be output as an electronic file and input to other programs that perform planning such as production, transportation, and construction. The design data stored in the design data storage section (131) can be output in table format likewise, but the geometric data can also be output in graphical format. In addition, the detail level data stared in the detail level data storage section (132) can be output in table format such as that shown in FIG. 9A, but can also be output in graph format such as that shown in FIG. 9B. Particularly when the detail level is represented by a continuous numerical value, the graph format is preferable.

FIGS. 2A to 2C are diagrams showing changes in design data that changes according to the progress of design. FIG. 2A shows the structure of columns and braces in an abstract state at the early design stage. Specifically, both the columns and the braces are represented by line segments. FIG. 2B shows an intermediate state. Although both columns and braces have thicknesses, it does not show at which portions the columns and the braces are cut. Only a part of a cutting portion may be represented. Though not shown in the drawing, between the states of FIGS. 2A and 2B there is also a state in which the states are mixed. FIG. 2C is a diagram showing a single column part in a detail state at the time close to the final design stage. It is common that a column has a geometry that a joint is attached by welding to a portion of the column that is connected to a brace, and bolt holes for assembly are made in the portion, which is shown in FIG. 2C. Though not shown in the drawing, there is also a state in which the states of FIGS. 2A, 2B, and 2C are mixed. Specifically, the state is such that some columns are represented by only line segments, some columns have thicknesses, and some columns have joints and bolt holes. At a structure production stage, a part in the form of FIG. 2C is produced and transported in this form and then construction is done on a construction site by fixing the part to other columns, braces, etc.

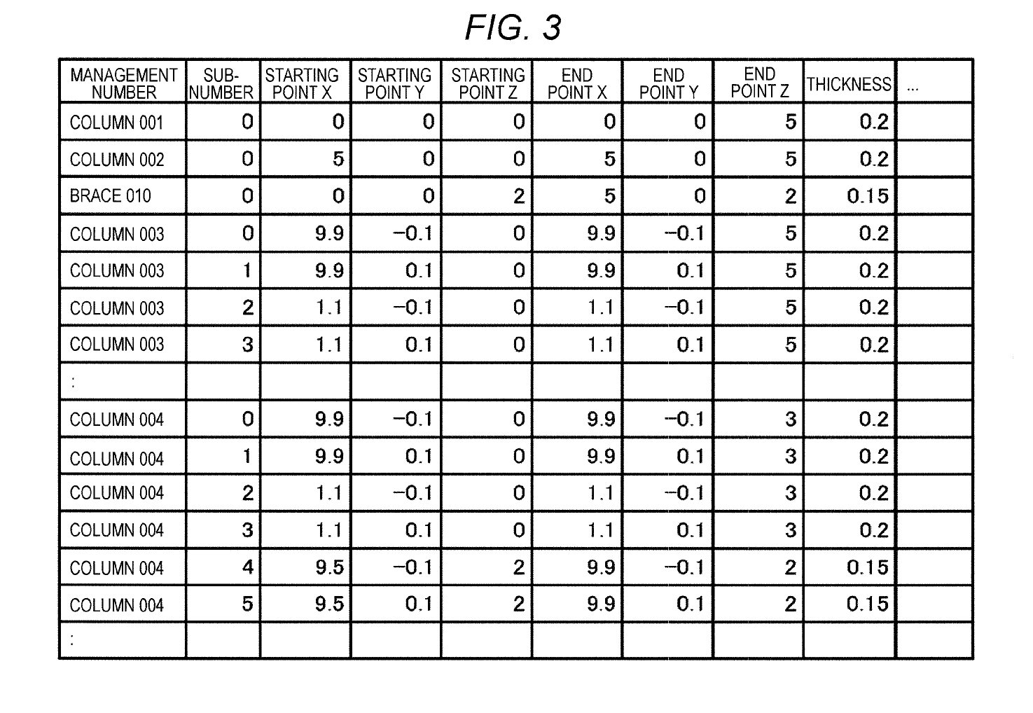

FIG. 3 shows an example of a table configuration of design data stored in the design data storage section (131) and an example of the data. The management numbers “column 001”, “column 002”, and “brace 010” each represent data for abstract which represents a single element by a single line segment. In addition, “column 003” represents data on a part of one column in an intermediate state that has a thickness. In addition, “column 004” represents data on a part of one column in a detail state that has a brace attachment portion.

The management number is a number for managing each element of design data. Normally, different numbers are assigned to different elements, but in the present invention the assignment method is not limited thereto. In this example, different numbers are assigned to different elements as geometries. The sub-number is a number for distinguishing between a plurality of data assigned the same management number. Since “column 003” and “column 004” each are represented by data of a plurality of rows, they are distinguished by sub-numbers. The starting and end points represent the coordinate locations of both ends of a line segment formed thereby. The thickness represents the thickness of a column or brace. Various other data can also be added to the design data. In addition, data on, for example, a solid having curves other than straight lines, surfaces, and volume can also be used.

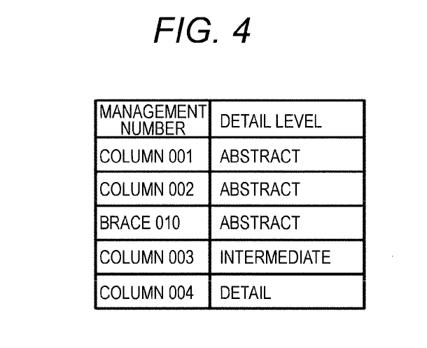

FIG. 4 shows an example of a table configuration of detail level data stored in the detail level data storage section (132) and an example of the data. The detail level, “abstract”, “intermediate”, or “detail”, is recorded for each element associated with a management number. Although in the present embodiment the detail level is classified into three levels, the number of classifications may be changed. Alternatively, the level may be represented by a continuous value. Note that the detail level data storage section (132) may be combined with the design data storage section (131), and the detail levels may be stored together with the design data by adding a column to the table of FIG. 3.

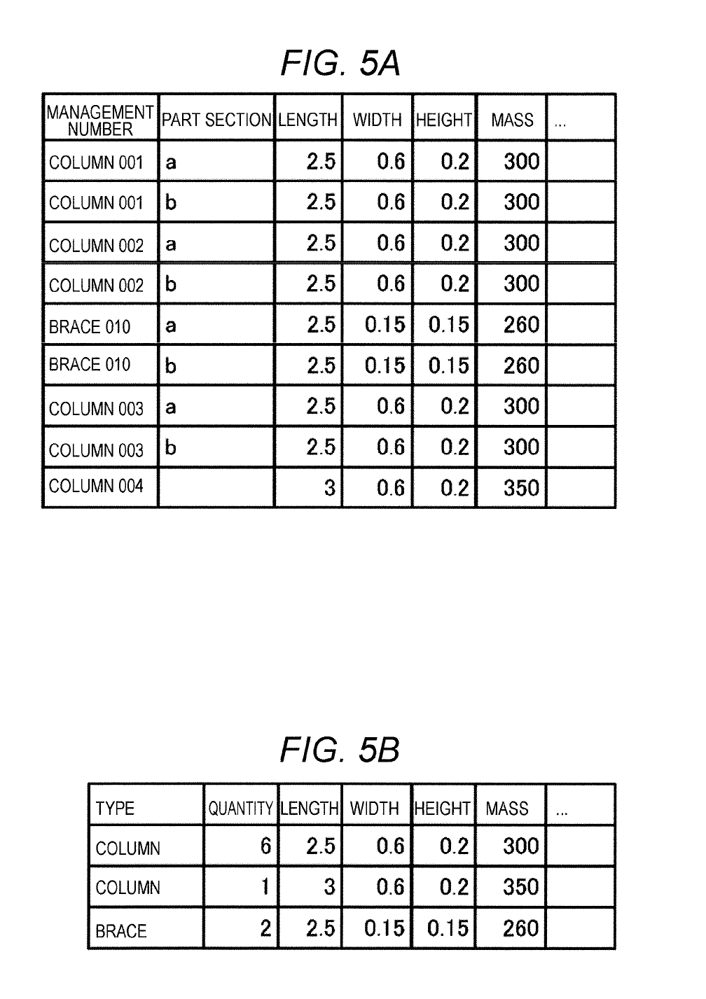

FIGS. 5A and 5B show examples of a table configuration of parts list data stored in the parts list data storage section (133) and examples of the data. FIG. 5A shows a table created individually for each management number, and FIG. 5B shows a table in which parts of the same specification are collected. In the present embodiment, a table can be created in both formats. In this example, the table is created assuming the conditions that a part exceeding 3 m in length cannot be transported and thus needs to be cut, and a column requires a joint for attaching a brace. Those data other than data on “column 004” is divided into part sections “a” and “b”. In FIG. 5A, the management numbers correspond to those of FIG. 3. The part sections are symbols for distinguishing between a plurality of cut parts assigned the same management number. The length, width, and height are the maximum dimensions in three directions of each part for when the part is placed stably. The mass is a value representing the mass of each part. FIG. 5B shows a table in which parts whose values other than management number and part section are identical are collected, and the number of the collected parts is represented as quantity. Those data can be output in the manner shown in FIGS. 8A and 8B, from the input/output apparatus (101) through the output control section (150), based on an instruction input from the input/output apparatus (101).

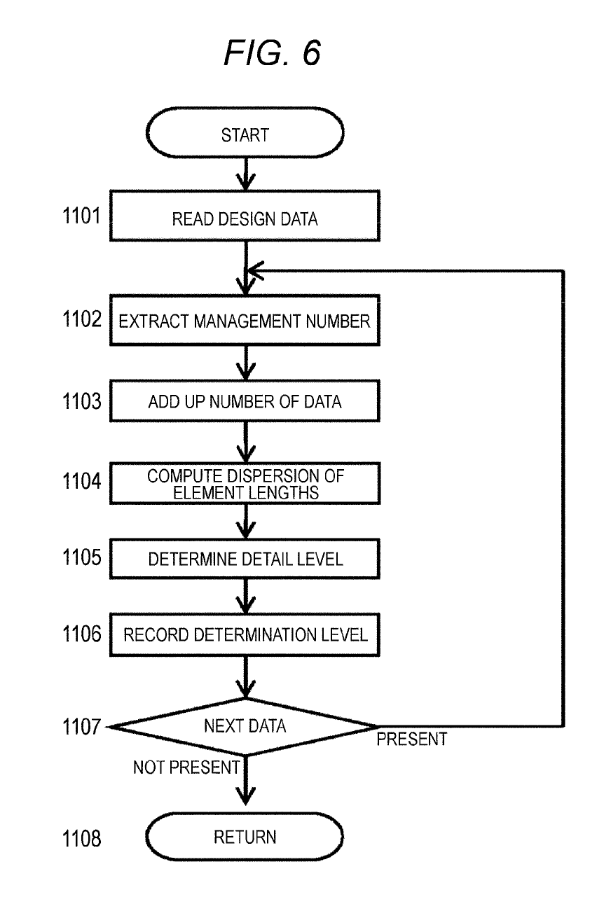

FIG. 6 is a diagram showing a flow of a process performed by the detail level determining section (142). First, design data stored in the design data storage section (131) is read (1101). Then, the management number of the first data is extracted (1102). Then, the number of data having the same management number as the extracted management number is added up (1103). In addition, the sizes of geometries (the lengths of line segments, etc.) represented by the data having the same management number as the extracted management number are computed, and the value of dispersion which is the statistical value of the sizes is computed (1104). It can be seen that the larger the value of dispersion the larger the variations, and the smaller the value the smaller the variations. Based on the number of data and the value of dispersion which are obtained at the above steps, a detail level is determined by a predetermined rule (1105). In general, it is highly likely to be “abstract” when the number of data is small and the dispersion is small, and it is highly like to be “detail” when the number of data is large and the dispersion is large. Thus, the determination is made based on such a criterion. Note that the determination can use a fixed number of classifications (e.g., three classifications) or can also use a continuous value (e.g., the number of data×the value of dispersion). Then, the obtained determination value is recorded in the detail level data storage section (132) (1106). It is determined whether there is next data (1107). If there is no data, then the process ends (1108). Otherwise, the processes at and after 1102 are repeated on data with the next management number. Note that although the present embodiment describes, as the method of determining a detail level, a method using the number of data and the sizes of geometries, in the present invention the determination method is not limited thereto.

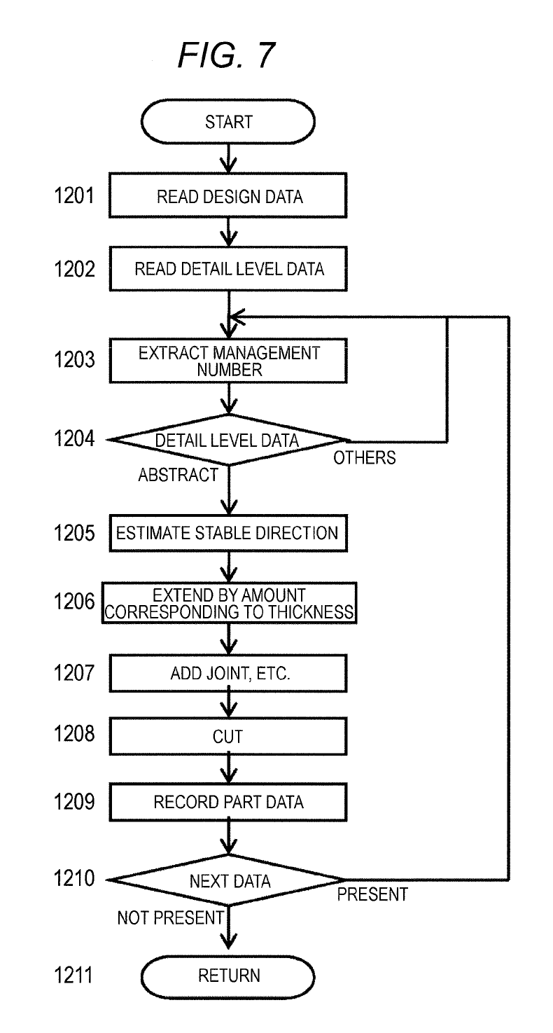

FIG. 7 is a diagram showing a flow of a process performed by the parts list data generating section 1 (143). First, design data stored in the design data storage section (131) is read (1201). Then, detail level data stored in the detail level data storage section (132) is read (1202). Then, the first management number is extracted (1203). Then, it is determined whether the detail level data associated with the extracted management number is “abstract” (1204). If not “abstract”, then the process moves to a process for data with the next management number. If “abstract”, then first, a stable direction is estimated (1205). In the present embodiment, by referring to the design data, the maximum and minimum coordinate values are extracted for each of data with the same management number and for each of the X-, Y-, and Z-directions, and differences therebetween are determined, and then the values of the differences are determined to be length, width, and height in order of decreasing the values. Note, however, that in the present invention the method is not limited thereto or this process itself is not essential. Then, using data on thickness included in the design data, width and height are extended by the amount corresponding to the thickness (1206). In the present embodiment, width and height have the same value but may have different values. Then, a joint portion, etc., are added (1207). This process varies depending on the type of part represented by data. For example, in the case of a column, a joint is required for attachment of a brace, and thus, a joint having a thickness and a length relevant to the original size, bolt holes at a connecting portion, etc., are added. In the case of a brace, bolt holes are added. Furthermore, a connecting portion between a column and a brace requires connecting plates, bolts, nuts, etc., and those parts may be added. Other examples will be described later. Then, when the obtained dimension or mass of the part exceeds its allowable value (e.g., when there are constraints on length or mass for transportation or construction work), the part is cut into some pieces so as to fall within the allowable value (1208). Then, the obtained data on the part is recorded in the parts list data storage section (133) (1209). It is determined whether there is next data (1210). If there is no data, then the process ends (1211). Otherwise, the processes at and after 1203 are repeated on data with the next management number.

The parts list data generating section 2 (144) and the parts list data generating section 3 (145) perform processes for the detail levels “intermediate” and “detail”, respectively. The processes are similar to that performed by the parts list data generating section 1 (143). The process performed by the parts list data generating section (144) is the same as that performed by the parts list data generating section 1 (143) except that it is determined at 1204 whether the detail level data is “intermediate” and that the extension by the amount corresponding to the thickness at 1206 is not required. The process performed by the parts list data generating section 3 (145) is the same as that performed by the parts list data generating section 1 (143) except that it is determined at 1204 whether the detail level data is “detail” and that the processes at 1206 to 1208 are not required. In the present embodiment, since the detail level is distinguished by three types, there are three types of portions that generate parts list data. However, when the types of level are changed, the number of portions that generate parts list data may be changed accordingly. When the detail level is represented by a continuous value, there is a method in which different processing portions are prepared for different predetermined determination value ranges, and there is also a method in which a process is performed by making a determination in a single processing portion. Although the above description is made using columns and braces, there is also a method in which different processing portions are prepared for different parts. For example, different processing portions may be prepared for a column and a brace, or dedicated processing portions may be prepared for a wire cable, piping, etc.

In the design of a wire cable, for abstract design data at the early design stage, a single bent line having connecting points as its both ends is used for each wire cable. When the design progresses, data on an electric conduit that protects the wire and data on a cable tray that fixes the wire are generated near the wire. To do so, in the present invention, the detail level determining section (142) searches for an electric conduit and a cable tray near the wire. If present then the data is determined to be “detail”, and if not present then the data is determined to be “abstract”. In addition, if there are other wires near the wire, then the parts list data generating section 1 (143) for abstract design data generates data on a cable tray together with data on the wire, and records the data in the parts list data storage section (133). If there are no other wires near the wire, then the parts list data generating section 1 (143) for abstract design data generates data on an electric conduit together with data on the wire, and records the data in the parts list data storage section (133). At this time, the specifications of an electric conduit and a cable tray are determined by predetermined rules, based on the specification of a wire, the number of wires near the wire, etc. In the parts list data generating section 3 (145) for detail design data, since data on the electric conduit and the cable tray is generated separately, the lengths of only the wires are added up to generate data, and the data is recorded in the parts list data storage section (133).

In the design of piping, for abstract design data at the early design stage, a single bent line having connecting points as its both ends is used for each piping. When the design progresses, thickness is added to the piping and fixing portions at both ends and in the middle are added. To do so, in the present invention, the detail level determining section (142) searches whether there is a thickness of the piping which is made into geometric data, and whether there is a support part near the piping. If present then the data is determined to be “detail”, and if not present then the data is determined to be “abstract”. In addition, the parts list data generating section 1 (143) for abstract design data estimates the geometry of the piping based on the data on thickness which is recorded as an attribute, and generates parts list data therefor and parts list data for the support part, and then records those data in the parts list data storage section (133). At this time, the specifications of thickness and a support part are determined by predetermined rules, based on the attribute data of the original piping data and the specification of the piping. Likewise, if there are constraints on length or mass for transportation or construction, then parts list data in a state of being cut according to the constraints is generated. In addition, in the parts list data generating section 3 (145) for detail design data, since parts list data for the support part is generated separately, parts list data is generated only for the piping, and the data is recorded in the parts list data storage section (133).

Output parts list data is not only displayed on a screen in the manner shown in FIGS. 8A and 8B, but is also used for production planning, transportation planning, construction planning, etc. In general, once a construction process has been determined, production and transportation schedules are determined correspondingly, and planning and management are performed such that parts list data is associated with each management unit. At each planning stage, there is a need to evaluate whether required work can be completed during a requested period. At that time, there is a need to use the quantities and characteristics of related parts, and it is preferred to use data generated and output by the method of the present invention. Hence, it is preferred that those data be added up for each management unit which is a planning object. For example, for production planning, it is appropriate to add up for each set of parts that require the same equipment in the same period. For transportation planning, it is appropriate to add up quantities, masses, volumes, etc., for each set of parts that are transported to the same location in the same period. For construction planning, it is appropriate to add up quantities, masses, volumes, etc., for each set of parts that are brought to the same location in the same period. Those adding up processes may be performed when the parts list data generating sections 1 to 3 (143 to 145) record data in the parts list data storage section (133), or may be performed in a system that aids planning such as production, transportation, and construction, after output from the input/output apparatus (101). In addition, a classification determination during an adding up process according to the purpose may use distinction data which is recorded as an attribute, or may use a rule provided for each purpose.

Furthermore, the case in which product data and detail level data are output and displayed on screens of FIGS. 9A and 9B is described. A design progress state can be grasped by the computer aided design apparatus (100) including: the storage apparatus (130) including the design data storage section (131) having product data recorded in a product data storage area and the detail level data storage section (132) that records the detail levels of the product data in a detail level data storage area; and the output control section (150) that displays a plurality of product data and the detail levels of the respective plurality of product data such that the product data and the detail levels are arranged in order of detail level. By this, if design is completed and sufficient parts list data by which materials can be added up is prepared, then efficient planning can be performed, but even in a situation where most data is abstract CAD data and parts list data is not in a detail state, product data and detail levels are associated with each other for production planning, transportation planning, and construction planning, enabling an operator to grasp the progress. Note that for this display, irrespective of the process performed by the detail level determining section in FIG. 6, calculated detail level data, etc., may be recorded as a database.

Note that the present invention is not limited to the above-described embodiment and includes various variants. For example, the above-described embodiment is described in detail for easy description of the present invention and thus is not necessarily limited to one including all of the described configurations. In addition, some configurations in a given embodiment may be replaced by configurations in other embodiments, or configurations in a given embodiment may have configurations in other embodiments added thereto. In addition, for some configurations in each embodiment, addition, removal, and replacement of other configurations may be performed.

Some or all of the above-described configurations, functions, processing sections, processing means, etc., may be implemented by hardware by, for example, designing them using an integrated circuit. In addition, the above-described configurations, functions, etc., may be implemented by software by a processor of a computer interpreting and executing a program that implements each function. A program that implements each function, tables, files, and information such as measurement information and calculation information can be placed in recording apparatuses such as a memory, a hard disk, and an SSD (Solid State Drive), or in recording media such as an IC card, an SD card, and a DVD. Thus, each process and each configuration can implement each function, as a processing section, a processing unit, a program module, etc.

What is claimed is:

1. A computer aided apparatus comprising:
a storage apparatus that records product data in a product data storage area;
a detail level determining means for determining a detail level of the product data stored in the storage area;
a parts list data generating means for generating parts list data from the product data, based on a result of the determination made by the detail level determining means; and
an output control means for outputting the parts list data generated by the parts list data generating means.

2. The computer aided apparatus according to claim 1, wherein the detail level determining means determines the detail level based on a quantity of geometric element data included in the product data or a size of a geometry represented by the geometric element data.

3. The computer aided apparatus according to claim 1, wherein
as the product data, there are at least two types of structural material, the two types being selected from among a geometry of a shape steel having a line segment and a thickness and a geometry having a joint and a hole, and
the detail level determining means determines a distinction between the at least two types.

4. The computer aided apparatus according to claim 1, comprising a means for handling, as the product data, a wire and an accessory in combination, the wire having a geometry representing a line segment or a wire, and the accessory being an electric conduit or a cable tray, wherein
the detail level determining means determines a distinction between the wire and the accessory being in combination.

5. The computer aided apparatus according to claim 1, comprising a means for handling, as the product data, piping and an accessory in combination, the piping having a geometry representing a line segment or piping, and the accessory being a support, wherein
the detail level determining means determines a distinction between the piping and the accessory being in combination.

6. A computer aided apparatus comprising:
a storage apparatus that records product data in a product data storage area;
a detail level determining means for determining a detail level of the product data stored in the storage area; and
an output control means for outputting a result of the determination made by the detail level determining means.

7. A computer aided method comprising:
a detail level determining step of determining by a computer, based on data in a recording apparatus that records product data in a product data storage area, a detail level of the product data stored in the storage area;
a parts list data generating step of generating parts list data from the product data, based on a result of the determination made in the detail level determining step; and
an output step of outputting the parts list data generated in the parts list data generating step.

8. A computer aided method comprising:
a detail level determining step of determining by a computer, based on data in a storage apparatus that records product data in a product data storage area, a detail level of the product data stored in the storage area; and
an output step of outputting a result of the determination made in the detail level determining step.

9. A computer aided apparatus comprising:
a storage apparatus that records product data in a product data storage area and records a detail level of the product data in a detail level data storage area; and
an output control means for displaying a plurality of product data and detail levels of the respective plurality of product data such that the product data and the detail levels are arranged in order of detail level.
